(19) United States
(12) Patent Application Publication
(10) Pub. No.: US 2006/0070659 A1
(43) Pub. Date: Apr. 6, 2006

(54) Method and apparatus for installation of a flow control valve for mounting a subterraneously positioned pipe

(75) Inventors: Douglas Bryan Nelson, LaPorte, IN (US); Michael Shawn Murphy, Oakbrook, IL (US)

Correspondence Address: ANTHONY S. ZUMMER, 39 S. LaSALLE SREET, SUITE 1428, CHICAGO, IL, 60603, US

(73) Assignee: Advanced Valve Technologies, Inc.

(21) Appl. No.: 10/959,023

(22) Filed: Oct. 5, 2004

(51) Int. Cl. F16K 27/00

(52) U.S. Cl. 137/318

(57) ABSTRACT

A method and valve assembly adapted for remote controlled mounting of the valve assembly on a subterraneously positioned pipe. The valve assembly is used to regulate flow of fluid through the pipe. The valve assembly includes a clamp having a base and jaw secured to the pipe. A stand tube is mounted on the clamp and receives a plunger. A resilient seat is mounted on the plunger to move selectively the plunger into and out of the pipe for regulating flow of fluid through the pipe.

### BACKGROUND OF THE INVENTION

The present invention relates to an improved valve construction and a method for installation of the valve in a subterraneously positioned pipe having fluid flowing through the pipe. The valve is attached to the pipe and has a control insert positionable in the pipe to regulate flow of fluid through the pipe.

In a distribution system for distributing a fluid, such as natural gas, pipes carrying the gas are customarily positioned subterraneously to protect the pipes from damage. Sometimes, it becomes necessary to add a valve to a pipe to control the flow of gas through the pipe. The first step during the typical installation of a valve is digging a hole in the ground above, surrounding and below the pipe. Typically, the hole is dug with a backhoe and is of a size to accommodate at least one workman. Often times, it is big enough to accommodate two workmen. The workman goes down into the excavation to install a valve by conventional and well known means. Once the valve is installed, it is necessary to replace the material that was remove in order to expose the pipe and provide room for workmen to install the valve. Thus, the cost of installation of a valve in a gas line is substantial because of the amount of material which must be excavated, and the cost of replacing the excavated material upon completion of the valve installation.

The present invention provides an improved valve construction which allows the valve to be installed in a pipe with a minimum of excavation of material.

### SUMMARY OF THE INVENTION

The present invention includes a method and apparatus for installing a valve in a subterraneously positioned pipe utilizing only a minimum of excavation.

Once the position of the valve to be installed in a selected pipe is determined, a hole is dug to the pipe. The hole has a diameter of approximately 30 inches and the pipe is exposed. A clamp with a closure apparatus is placed into the hole with a clamp base mounted on the pipe. A closure apparatus includes a means for remotely controlling a cylinder to move a clamp jaw into engagement with the pipe and simultaneously position a fastener proximate an ear mounted on the clamp base. The fastener is tightened from a remote position to lock the clamp jaw to the clamp base and thereby secure the clamp to the pipe. The closure apparatus is then removed and a conventional valve insertion apparatus is mounted on a stand pipe connected to the clamp. The insertion apparatus has a cutter mounted therein to cut a coupon from the pipe to form an aperture in the pipe. The cutter with the coupon is removed from the pipe and an insertion apparatus valve is closed. The cutter is removed from the valve insertion apparatus. A valve assembly is then mounted on a shaft and is positioned in the valve insertion apparatus. The insertion apparatus valve is opened, and the valve assembly is positioned in the stand pipe. The insertion apparatus is removed and a fitting cap is mounted on the valve assembly and the stand tube.

The valve includes an actuator body which is secured to the stand tube. A plunger having a non-circular cross section is slidably mounted in a mating aperture in the actuator body. The plunger carries a rubber seat. A feed screw is rotatably mounted in the actuator body and is threadedly connected to the plunger, so that rotation of the feed screw in one direction will insert the rubber seat into the pipe to control the flow of fluid through the pipe and rotation of the feed screw in the opposite direction will move the seat from the pipe to allow fluid to flow to the pipe thereby regulating flow of fluid through the pipe. The feed screw may be operated remotely.

Upon completion of the installation of the valve, the material removed to expose the pipe is returned thereby effecting an efficiency in the installation of the valve by minimizing the amount of material removed to expose the pipe and returning that material upon successful installation of the valve.

### BRIEF DESCRIPTION OF THE DRAWINGS

FIG. 1 is a cross sectional view through a subterraneously positioned pipe with material excavated to expose the pipe with a clamp having a clamp base positioned on the pipe and a closure assembly connected to the clamp;

FIG. 2 is a cross sectional view showing the clamp attached to the pipe and a fastener attached to the clamp jaw and clamp base;

FIG. 3 is a side elevational view taken on Line 3-3 of FIG. 2 showing a pair of fasteners securing the clamp jaw to the clamp base;

FIG. 4 is a partial cross sectional view showing a portion of a valve insertion apparatus with a coupon cutter in position after cutting a coupon from the pipe;

FIG. 5 is a partial cross sectional view showing a valve assembly in the valve insertion apparatus positioned in the stand tube;

FIG. 6 is a cross sectional view of the valve in position allowing fluid to flow through the pipe;

FIG. 7 is a cross sectional view taken on Line 7-7 of FIG. 6 showing the non-circular cross section of the plunger positioned in a mating aperture in the actuator body; and

FIG. 8 is a cross sectional view similar to FIG. 6, but showing the valve in an attitude for interrupting flow of fluid through the pipe.

### DETAILED DESCRIPTION OF THE INVENTION

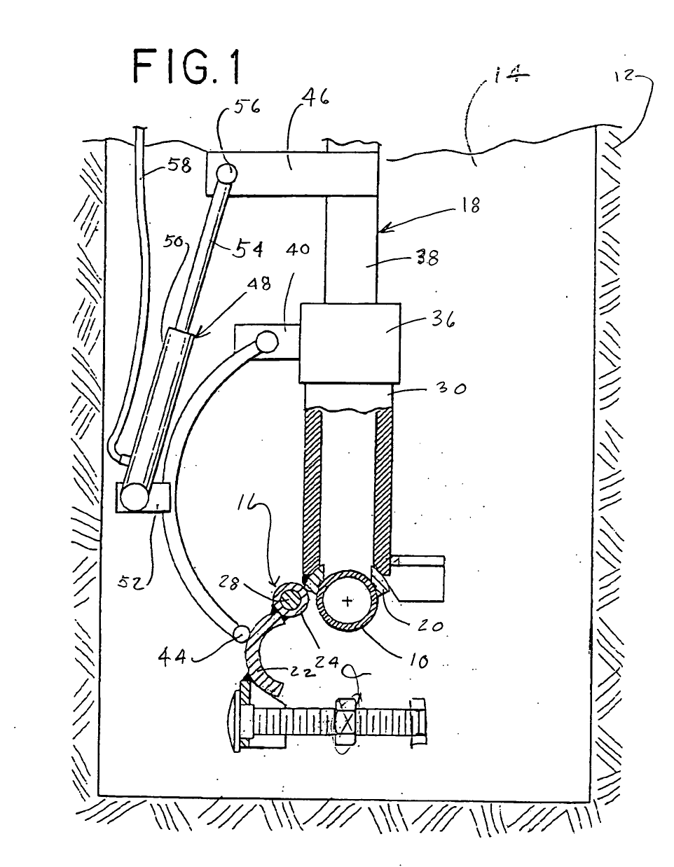

Referring now to the drawings, and especially to FIG. 1, a pipe 10 is shown therein. The pipe in this instance is part of a fluid distribution system, and in particular, a natural gas distribution system. The pipe is subterraneous positioned to protect it from damage. To add a valve into the distribution system, and in particular, pipe 10, the pipe must be exposed. Earth 12 is excavated to the pipe to form excavation 14. In this instance, the excavation has a diameter of approximately 30 inches. The excavation may be accomplished by any well known means, such as an auger hole digger. However, any other suitable means may be utilized. Once the pipe 10 is exposed, it is cleaned remotely in order to remove any dirt on the pipe. It is not necessary for a workman to enter the excavation to reach the pipe.

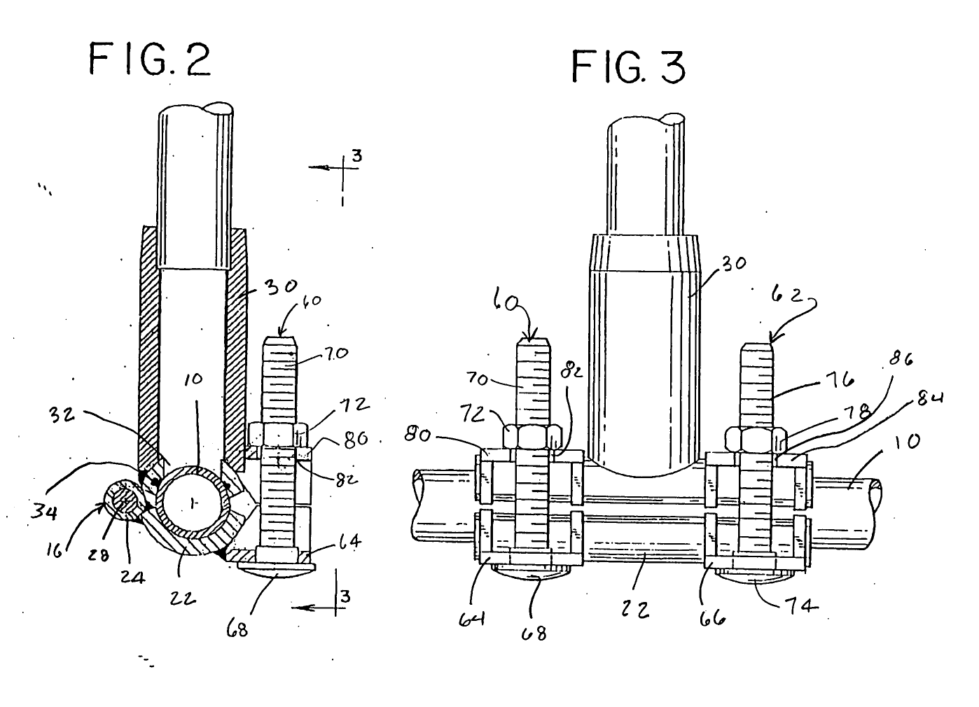

A clamp 16 with a clamp closure apparatus 18 is inserted into the excavation 14. Clamp 16 includes a clamp base 20 which has an interior surface which mates with the exterior surface of pipe 10. The clamp includes a clamp jaw 22 pivotly connected to base 20 through hinge 24. Hinge 24 includes a receptacle 26 welded to the clamp jaw and a clamp axle 28 connected to clamp base 20. A stand tube 30 is sealingly mounted on base 20. As may be seen in FIG. 2, base 20 contains an aperture 32 which is aligned with the interior of stand tube 30. A seal 34 is mounted in the interior surface of base 20 surrounding aperture 32 so that there is a seal between base 20 and pipe 10 around aperture 32 forming a fluid tight junction.

Closure apparatus 18 includes a closure head 36 which is mounted on stand tube 30. A post 38 is connected to closure head 36 and to stand tube 30. An arm mount 40 is mounted on closure head 36. A curved closure arm 42 is pivotly mounted on the arm mount 40. The closure arm includes a contact 44 slidably engaging clamp jaw 22. A cylinder support arm 46 is mounted on cylinder post 38. A pneumatic cylinder 48 has a tube 50 pivotly connected to a cylinder mount 52 secured to closure arm 42. The cylinder has a rod 54 pivotly connected to cylinder support arm 46 through a rod pivot 56. A pneumatic line 58 is connected to the cylinder 48 and extends to a source of air under pressure from a conventional and well known source not shown herein.

Clamp 16 includes a pair of fasteners 60 and 62, best shown in FIG. 3. Fastener 60 is mounted in a generally U-shaped bracket 64 and fastener 62 is mounted in a like U-shaped bracket 66. The U-shaped brackets 64 and 66 are welded to jaw 22. Fastener 60 includes a head 68 mounted in bracket 64 and a threaded shank 70 fixed to head 68. A nut 72 is threadedly mounted on threaded shank 70. In a like manner, fastener 62 includes a head 74 mounted in bracket 66 with a threaded shank 76 fixed to head 72. A conventional nut 78 is threadedly mounted on threaded shank 76.

A slotted ear 80 is welded to base 20 and includes a slot 82 for receiving threaded shank 70. A slotted ear 84 is welded to base 20 and includes a slot 86 for receiving threaded shank 76.

Clamp 16 with the clamp apparatus is initially inserted into excavation 14 with clamp jaw 22 in an open position. The clamp with the closure apparatus is moved laterally and then vertically so that the clamp is positioned with clamp base 20 on pipe 10, so that stand tube 30 extends radially away from pipe 10 and is perpendicular to the pipe. Positioning of the clamp with the closure apparatus is accomplished without a workman entering the excavation. Once the clamp base is securely resting on the pipe, cylinder 48 is activated by a remote control outside of excavation 14 to pivot arm 42 and thus pivot clamp jaw 22 about its hinge. The pivoting of the clamp jaw allows the threaded shanks 70 and 76 to enter their respective slots 82 and 86 of ears 80 and 84, respectively. Upon positioning of the threaded shanks in respective ears, a socket with a long handle (not shown here) is inserted into the excavation to engage nuts 72 and 78 serially. The nuts are tightened remotely so that the fasteners hold jaw 22 in secure engagement with the pipe. Once the fasteners are secured, the closure apparatus is removed from the stand tube.

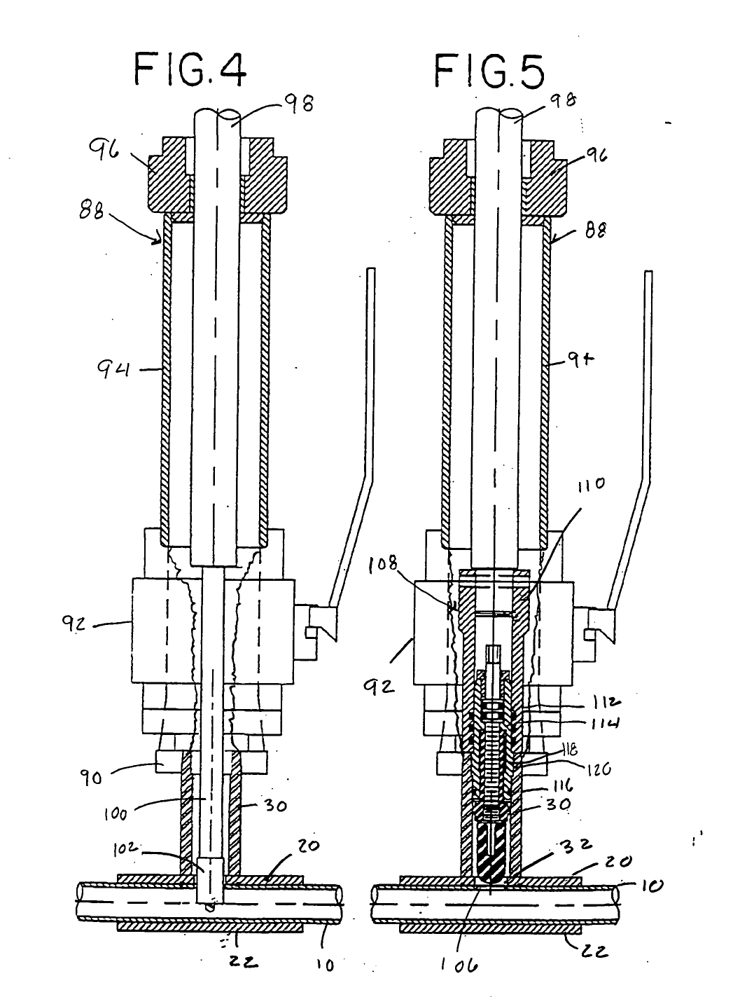

A conventional and well known valve insertion assembly 88 is then mounted on stand tube 30. Assembly 88 is dropped down onto the stand tube and assembly connector 90 is threaded onto the end of stand tube 30. As is conventional, assembly 88 includes an assembly valve 92 which is connected to an assembly tube 94. An assembly head 96 is mounted on the assembly tube. An assembly shaft 98 is rotatably and sealingly mounted in assembly head 96. The assembly shaft has a cutter shaft 100 secured thereon with a conventional cutter 102 mounted on the end of the cutter shaft, as shown in FIG. 4. Shaft 98 is rotated from above ground so that cutter 102 is rotated to cut a coupon out of the pipe. Removal of the coupon forms a pipe aperture 106 which is aligned with aperture 32 and the opening of stand tube 30. The coupon, as is conventional, is raised up above valve 92. The valve is closed and the cutter with the coupon is then retracted.

A valve insertion assembly 108 is mounted on shaft 98. Valve 92 is opened and assembly 108 is positioned adjacent to stand tube 30. The valve insertion assembly includes a valve holder 110 which receives a valve assembly 112. The valve assembly includes an actuator body 114 which is sealingly mounted in holder 110. The actuator body has a seal 116 which sealingly engages the interior of stand tube 30. The actuator body has a threaded portion 118 which threadedly engages an interiorly threaded portion 120 of the stand tube to connect the actuator body to the stand tube. Shaft 98 rotates the actuator body relative to the stand tube to threadedly connect the actuator body with the stand tube. Valve holder 110 is then disengaged from the actuator body and retracted. Connector 90 is then disengaged from the stand tube, so that assembly apparatus 88 may then be disengaged from the stand tube and retracted.

A fitting cap 122 is threadedly mounted on the end of the stand tube and sealingly engages actuator body 114. The actuator body has a retaining nut 124 mounted in its upper end sealingly and rotatably engaging feed screw 126. The feed screw has a pair of seals 128 and 130 engaging the interior of the actuator body. A plunger 132 threadedly engages the threaded portion of the feed screw. The exterior of the plunger is an irregular hexagon, as shown in FIG. 7. The plunger mates with portion 134 of the actuator body so that there is no rotation between the plunger and the actuator body. The plunger has an enlarged circular collar 136 which rides in the stand tube 30. Support shaft 136 is threadedly mounted in the end of the plunger and a resilient rubber seat 138 is mounted on support shaft 136.

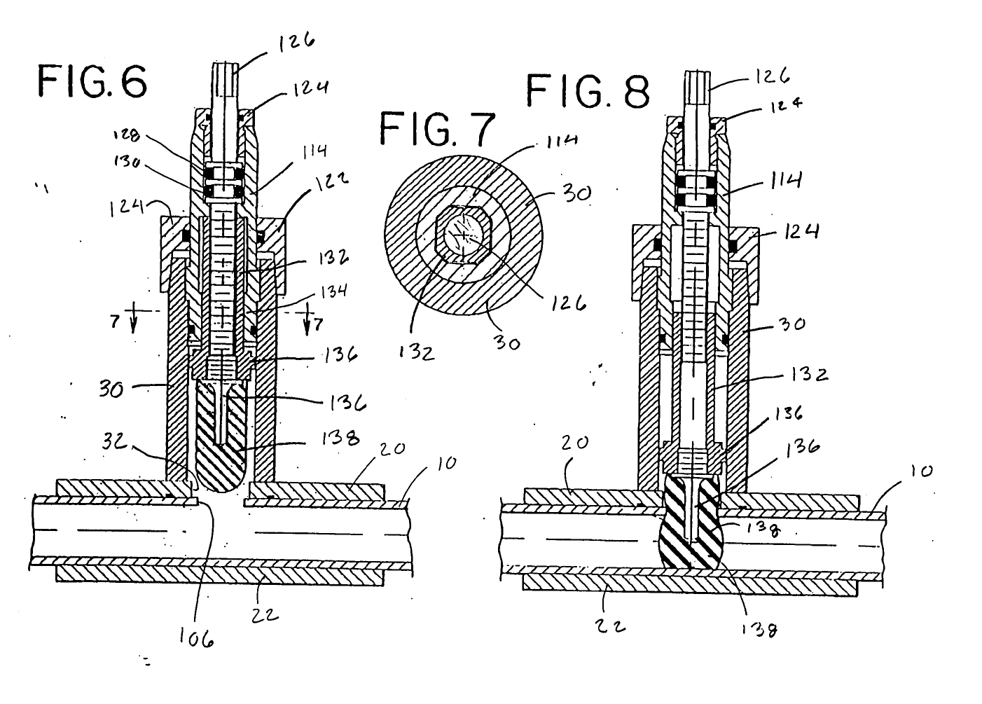

A conventional elongated valve operator (not shown herein) extending above the excavation engages the end of the feed screw 126. When the valve operator rotates feed screw 126 in one direction, it forces the plunger downward as viewed in FIG. 6, so that rubber seat 138 passes through the aperture 106 in the pipe and engages the interior of the pipe, as seen in FIG. 8, to interrupt the flow of natural gas through pipe 10, thus providing means for regulating flow through the pipe. Rotation of the feed screw in the opposite direction cause the plunger to rise and carry with it the rubber seat and thereby allow gas to flow through the pipe. Thus, the valve regulates the flow of gas through the pipe.

Once the valve installation has been completed, the excavated material is returned to excavation 14. The material is substantially less than that which is required to provide an excavation large enough to accommodate a workman. Thus, the valve is inserted efficiently by the reduction in the amount of material to be excavated utilizing the remote clamping ability of the present assembly.

The description of the above-mentioned invention has been described in terms of use with natural gas. It is readily apparent that the subject invention may be used for other fluids. Although the invention has been described in detail above, it is readily apparent that those skilled in the art may make various modifications and changes in the instant invention without departing from the spirit and scope of the present invention. It is to be expressly understood that the instant invention is limited only by the appended claims.

What is claimed is:

1. A valve assembly adapted for remote controlled mounting on a subterraneously positioned pipe to regulate flow of fluid through the pipe including; a clamp base having an aperture and an interior surface being substantially mateable with a portion of the pipe, a clamp jaw hingedly connected to the clamp base and being movable by a remote controlled operator, a fastener connected to the clamp base and to the clamp jaw and being secured by a remotely positioned power source, a stand tube sealingly fixed to the base portion surrounding the aperture, said stand tube extending outward from the interior surface, said pipe having a pipe aperture aligned with the aperture of the jaw base, a plunger movably mounted in the stand tube, a resilient seat mounted on the plunger to move with the plunger, and means connected to the plunger to move the plunger in the stand tube for selectively moving the seat into the pipe through the pipe aperture for selectively regulating flow of a fluid through the pipe.

2. A valve assembly adapted for remote controlled mounting on a subterraneously positioned pipe to regulate flow of fluid through the pipe as defined in claim 1, wherein the fastener is mounted on the clamp jaw and is moveable with the clamp jaw to be positioned adjacent to the clamp base for securing the clamp jaw to the clamp base.

3. A valve assembly adapted for remote controlled mounting on a subterraneously positioned pipe to regulate flow of fluid through the pipe as defined in claim 1, wherein the fastener is mounted on the clamp jaw and is moveable with the clamp jaw, and including an ear mounted on the clamp base, said ear having a slot receiving the fastener when the clamp jaw is pivoted relative to the base and the fastener is connected to the ear to secure the clamp to the pipe.

4. A valve assembly adapted for remote controlled mounting on a subterraneously positioned pipe to regulate flow of fluid through the pipe as defined in claim 1, including; an actuator body mounted in the stand tube, said plunger movably mounted in the actuator body, and a feed screw rotatably mounted in the actuator body and threadedly connected to the plunger for moving the plunger within the stand tube.

5. A valve assembly adapted for remote controlled mounting on a subterraneously positioned pipe to regulate flow of fluid through the pipe as defined in claim 1, including; a seal mounted on the interior surface surrounding the aperture and being engageable with the pipe to form a fluid tight junction between the interior surface and the pipe around the aperture.

6. A valve assembly adapted for remote controlled mounting on a subterraneously positioned pipe to regulate flow of fluid through the pipe as defined in claim 1, wherein the fastener is mounted on the clamp jaw and is movable with the clamp jaw, and including, an ear mounted on the clamp base, said ear having a slot for receiving the fastener when the clamp jaw is pivoted relative to the base and the fastener is connected to the ear to secure the clamp to the pipe, an actuator body mounted in the stand tube, said plunger movably mounted in the actuator body, and a feed screw rotatably mounted in the actuator body and threadedly connected to the plunger for moving the plunger within the stand tube.

7. A valve assembly adapted for remote controlled mounting on a subterraneously positioned pipe to regulate flow of fluid through the pipe as defined in claim 1, wherein the fastener is mounted on the clamp jaw and is movable with the clamp jaw to be positioned adjacent to the clamp base for connecting the clamp jaw to the clamp base, and including, an actuator body mounted in the stand tube, said plunger movably mounted in the actuator body, and a feed screw rotatably mounted in the actuator body and threadedly connected to the plunger for moving the plunger within the stand tube.

8. A valve assembly adapted for remote controlled mounting on a subterraneously positioned pipe to regulate flow of fluid through the pipe as defined in claim 1, wherein the fastener is mounted on the clamp jaw and is movable with the clamp jaw to be positioned adjacent to the clamp jaw for connecting the clamp jaw to the clamp base, and including, a seal mounted on the interior surface surrounding the aperture and being engageable with the pipe to form a fluid tight junction between the interior surface and the pipe around the aperture.

9. A valve assembly adapted for remote controlled mounting on a subterraneously positioned pipe to regulate flow of fluid through the pipe as defined in claim 1, wherein the fastener is mounted on the clamp jaw and is movable with the clamp jaw, and including, an ear mounted on the clamp base, said ear having a slot receiving the fastener when the clamp jaw is pivoted relative to the base, said fastener is connected to the ear to secure the clamp to the pipe, and a seal mounted on the interior surface surrounding the aperture and being engageable with the pipe to form a fluid tight junction between the interior surface and the pipe around the aperture.

10. A valve assembly adapted for remote controlled mounting on a subterraneously positioned pipe to regulate flow of fluid through the pipe as defined in claim 1, wherein the fastener is mounted on the clamp jaw and is movable with the clamp jaw, and including, an ear mounted on the clamp base, said ear having a slot for receiving the fastener when the clamp jaw is pivoted relative to the base, said fastener is connected to the ear to secure the clamp to the pipe, a seal mounted on the interior surface surrounding the aperture and being engageable with the pipe to form a fluid tight junction between the interior surface and the pipe around the aperture, an actuator body mounted in the stand tube, said plunger movably mounted in the actuator body, and a feed screw threadedly mounted in the actuator body and threadedly connected to the plunger for moving the plunger within the stand tube.

11. A valve assembly adapted for remote controlled mounting on a subterraneously positioned pipe to regulate flow of fluid through the pipe, including; a clamp base having an aperture and an interior surface being substantially mateable with a portion of the pipe, a clamp jaw hingedly connected the base, an operator arm connectable with the clamp jaw and a remote controlled movement assembly connected to the arm for moving the arm to move the clamp jaw into engagement with the pipe.

12. A valve assembly adapted for remote controlled mounting on a subterraneously positioned pipe to regulate flow of fluid through the pipe, as defined in claim 11, including; a fastener connected to the clamp base and the clamp jaw.

13. A valve assembly adapted for remote controlled mounting on a subterraneously positioned pipe to regulate flow of fluid through the pipe, as defined in claim 11, including; a slotted ear mounted on the clamp base, and an elongated fastener mounted on the clamp jaw wherein said fastener is positioned in a slot in the ear when the clamp jaw is positioned in engagement with the pipe, said fastener including a nut rotatable by a power source remotely positioned to secure the fastener to the clamp base.

14. A valve assembly adapted for remote controlled mounting on a subterraneously positioned pipe to regulate flow of fluid through the pipe, as defined in claim 11, including; a seal mounted on the interior surface surrounding the aperture and being engageable with the pipe to form a fluid tight junction between the interior surface and the pipe around the aperture.

15. A valve assembly adapted for remote controlled mounting on a subterraneously positioned pipe to regulate flow of fluid through the pipe, as defined in claim 11, including; a fastener connected to the clamp base and the clamp jaw, said fastener including, a nut rotatable by a power source remotely positioned from the nut to secure the fastener to the clamp base.

16. A valve assembly adapted for remote controlled mounting on a subterraneously positioned pipe to regulate flow of fluid through the pipe, as defined in claim 11, including; a slotted ear mounted on the clamp base, an elongated fastener mounted on the clamp jaw wherein said fastener is positioned in a slot in the ear when the clamp jaw is positioned in engagement with the pipe, said fastener including a nut rotatable by a power source remotely positioned from the nut to secure the fastener to the clamp base to hold the clamp jaw in juxtaposition to the clamp base and a seal mounted on the interior surface surrounding the aperture and being engageable with the pipe to form a fluid tight junction between the interior surface and the pipe around the aperture.

17. A method for controlling flow of a fluid through a subterraneously positioned pipe including the steps of: removing material to expose the pipe, positioning a clamp base having a stand tube on the pipe, closing a clamp jaw with a closing apparatus, tightening a fastener connecting the clamp jaw to the clamp base to secure the clamp jaw and clamp base to the pipe, cutting an aperture through a wall of the pipe and inserting a resilient seat into the pipe aperture through the stand tube to regulate the flow of fluid through the pipe.

18. A method for controlling flow of a fluid through a subterraneously positioned pipe as defined in claim 17, including; removing the apparatus to close the clamp jaw after the clamp jaw is closed and tightening the fastener to connect the clamp jaw to the clamp base.

19. A method for controlling flow of a fluid through a subterraneously positioned pipe as defined in claim 17, including; positioning a valve body connected to the resilient seat in the stand tube for moving the resilient seat relative to the stand tube.

20. A method for controlling flow of a fluid through a subterraneously positioned pipe as defined in claim 17, including; removing the apparatus to close the clamp jaw after the clamp jaw is closed and the fastener connects the clamp jaw to the clamp base and positioning a valve body connected to the resilient seat in the stand tube for moving the resilient seat relative to the stand tube.

21. A method for controlling flow of a fluid through a subterraneously positioned pipe as defined in claim 17, including; removing the apparatus to close the clamp jaw after the clamp jaw is closed and the fastener connects the clamp jaw to the clamp base, and mounting a valve insertion assembly on the stand tube to insert a valve assembly into the stand tube.

22. A method for controlling flow of a fluid through a subterraneously positioned pipe as defined in claim 17, including; removing the apparatus to close the clamp jaw after the clamp jaw is closed and the fastener connects the clamp jaw to the clamp base, mounting a valve insertion assembly on the stand tube after the apparatus to close the clamp jaw is removed, and positioning a valve body connected to the valve seat in the stand tube for moving the resilient seat relative to the stand tube.
